(19) United States
(12) Patent Application Publication
(10) Pub. No.: US 2007/0279215 A1
(43) Pub. Date: Dec. 6, 2007

(54) SENSITIVITY ADJUSTABLE INTRUSION DETECTING SYSTEM

(75) Inventors: Hiroyuki TOMOOKA, Otsu-shi (JP); Motohiro Watanabe, Otsu-shi (JP)

Correspondence Address: SUGHRUE MION, PLLC, 2100 PENNSYLVANIA AVENUE, N.W., SUITE 800, WASHINGTON, DC, 20037, US

(73) Assignee: OPTEX CO., LTD., Otsu-shi (JP)

(21) Appl. No.: 11/758,162

(22) Filed: Jun. 5, 2007

(30) Foreign Application Priority Data
Jun. 6, 2006 (JP) 2006-156991

(51) Int. Cl. G08B 19/00; G08B 29/00; G08B 13/18

(52) U.S. Cl. 340/522; 340/511; 340/556

(57) ABSTRACT

To provide a sensitivity adjustable intrusion detecting system capable of detecting the presence of a person assuredly even under the environment where the object such as a person is difficult to be detected, thereby avoiding an erroneous operation, the sensitivity adjustable intrusion detecting system is so designed that since the detecting sensitivity of the main detecting unit 1 is altered in response to detection by the auxiliary detecting unit 2 and when such detecting sensitivity of the main detecting unit is so increased at the time the necessity to detect the presence or absence of the human body H entering in one of the main detection areas encompassed within the supervised sector, the detecting sensitivity of the main detecting unit is increased to allow the human body to be assuredly detected under the environment where the human body is difficult to be detected, thereby avoiding an erroneous operation.

### BACKGROUND OF THE INVENTION

1. Field of the Invention

The present invention relates to an intrusion detecting system of a sensitivity adjustable type, which can be used to detect an intruder entering a detection area defined inside and outside of a building such as, for example, residence or factory.

2. Description of the Prior Art

Hitherto, the intrusion detecting apparatus has been known, which has a capability of detecting, with a passive type infrared sensor (PIR sensor), an unauthorized intruder entering within a detection area defined in the premises of a residence or a factory. However, when the difference between the human body temperature and the ambient temperature is small because of the unbearable weather observable on days of real summer heat during the summer season, the conventional intrusion detecting apparatus is incapable of detecting an unauthorized intruder. Because of this, it may be contemplated to increase the detecting sensitivity of the intrusion detecting apparatus on such occasions, but increase of the detecting sensitivity may cause the sensor to be too sensitive enough to erroneously detect, for example, a small animal, plants or leaves trembling in the breeze, or a person or other objects standing a distance away from the position of the intrusion detecting apparatus.

On the other hand, in order to avoid such an erroneous operation with a person and a small animal, the system has been suggested in, for example, Japanese Laid-open Patent Publication No. 2005-221455, in which while the use is made of near and far detection areas, the sensor, when detecting the presence of an object within the detection area regardless of whether it is the near detection area or the far detection area, can discriminate between a person and a small animal by the utilization of information on the difference in height between the person and the small animal and then issue an alarm signal indicative of the presence of the person.

It has, however, been found that even though the near and far detection areas are defined, the known intrusion detecting apparatus is still incapable of detecting an entry of an unauthorized intruder particularly where the difference between the temperature of the person and the ambient temperature is small. If the detecting sensitivities of sensors assigned to monitor the near and far detection areas, respectively, are increased, a similar erroneous operation is propense to occur in such a way as to detect the presence of the object standing a distance away from the apparatus.

### SUMMARY OF THE INVENTION

In view of the foregoing, the present invention has been devised to substantially eliminate the foregoing problems and inconveniences inherent in the conventional intrusion detecting apparatuses and is intended to provide an improved intrusion detecting system of a sensitivity adjustable type, which is capable of detecting the presence of a person assuredly even under the environment where the object such as a person is difficult to be detected, thereby avoiding an erroneous operation.

In order to accomplish the foregoing object, the present invention provides a sensitivity adjustable intrusion detecting system, which includes a main detecting unit including a passive type infrared detector for detecting an object present within a main detection area encompassed within a supervised sector, an auxiliary detecting unit for detecting an object present within a auxiliary detection area defined in the vicinity of or inside the main detection area, and a sensitivity increasing unit for increasing the detecting sensitivity of the main detecting unit in response to detection by the auxiliary detecting unit.

According to the present invention, the detecting sensitivity of the main detecting unit is increased in response to detection in the auxiliary detection area by the auxiliary detecting unit and, accordingly, only when detection is required to be made in the main detection area, which is encompassed within the supervised sector, the detecting sensitivity of the main detecting unit is increased to facilitate detection of the presence of a person under the environment where the object including the person is difficult to be detected. By so doing, the erroneous operation of the intrusion detecting system can be substantially avoided advantageously.

In a preferred embodiment of the present invention, the intrusion detecting system of the present invention may also include an increased sensitivity holding circuit for holding the detecting sensitivity of the main detecting unit, which has been increased, for a predetermined hold time. By way of example, if the length of time during which the increased detecting sensitivity is held is shortened, it is possible to avoid an erroneous operation resulting from detection of a small animal within the main detection area.

The sensitivity increasing unit referred to above may include an amplifier for amplifying a detection signal indicative of the presence of an object, which is outputted from the main detecting unit, and an amplification factor switching circuit for increasing the amplification factor of the amplifier. Also, the sensitivity increasing unit referred to above may preferably include a threshold changing circuit for lowering a determination threshold value in a signal processing circuit for processing the detection signal indicative of the object outputted from the main detecting unit. According to those structural features, the detecting sensitivity of the main detecting unit can be increased advantageously with a simplified structure.

In another preferred embodiment of the present invention, the sensitivity increasing unit referred to above may include two amplifier having different amplification factors and operable to amplify a detection signal indicative of an object, which has been outputted from the main detecting unit, and a signal selecting circuit for selecting one of respective output signals of the amplifiers. Alternatively, the sensitivity increasing unit may include two amplifier having different amplification factors and operable to amplify a detection signal indicative of an object, which has been outputted from the main detecting unit, and an amplifier switching circuit for switching from one of the amplifiers over to the other of the amplifiers. According to those structural features, the detecting sensitivity of the main detecting unit can be increased advantageously with a simplified structure.

In a further preferred embodiment, the sensitivity increasing unit referred to above may include a signal holding circuit for holding a detection signal outputted from the auxiliary detecting unit when the latter detects an object, and a signal calculating circuit for calculating and outputting a detection signal indicative of an object, which is outputted from the main detecting unit when the latter detects such object after the auxiliary detecting unit has detected the object, and the detection signal of the auxiliary detecting unit held in the detection signal holding circuit. Again alternatively, the sensitivity increasing unit may include two sensitivity processing circuits for causing a signal processing for processing the detection signal indicative of the object, which has been outputted from the main detecting unit, to be performed according to one of different detection sensitivities. and a sensitivity switching circuit for selecting one of the sensitivity processing circuits. According to those structural features, the detecting sensitivity of the main detecting unit can be increased advantageously with a simplified structure.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic side view showing an optical arrangement of a sensitivity adjustable intrusion detecting system according to a first preferred embodiment of the present invention;

FIG. 2 is a schematic top plan view of the sensitivity adjustable intrusion detecting system shown in FIG. 1 as viewed from above;

FIG. 3 is a circuit block diagram showing an electric circuit employed in the sensitivity adjustable intrusion detecting system shown in FIG. 1;

FIG. 4 is a circuit block diagram showing an electric circuit employed in the sensitivity adjustable intrusion detecting system according to a second preferred embodiment of the present invention;

FIG. 5 is a circuit block diagram showing an electric circuit employed in the sensitivity adjustable intrusion detecting system according to a third preferred embodiment of the present invention;

FIG. 6 is a circuit block diagram showing an electric circuit employed in the sensitivity adjustable intrusion detecting system according to a fourth preferred embodiment of the present invention;

FIG. 7 is a circuit block diagram showing an electric circuit employed in the sensitivity adjustable intrusion detecting system according to a fifth preferred embodiment of the present invention; and

FIG. 8 is a schematic side view showing an optical arrangement of a sensitivity adjustable intrusion detecting system according to a sixth preferred embodiment of the present invention.

### DETAILED DESCRIPTION OF THE EMBODIMENTS

Preferred embodiments of the present invention will now be described in detail with reference to the accompanying drawings.

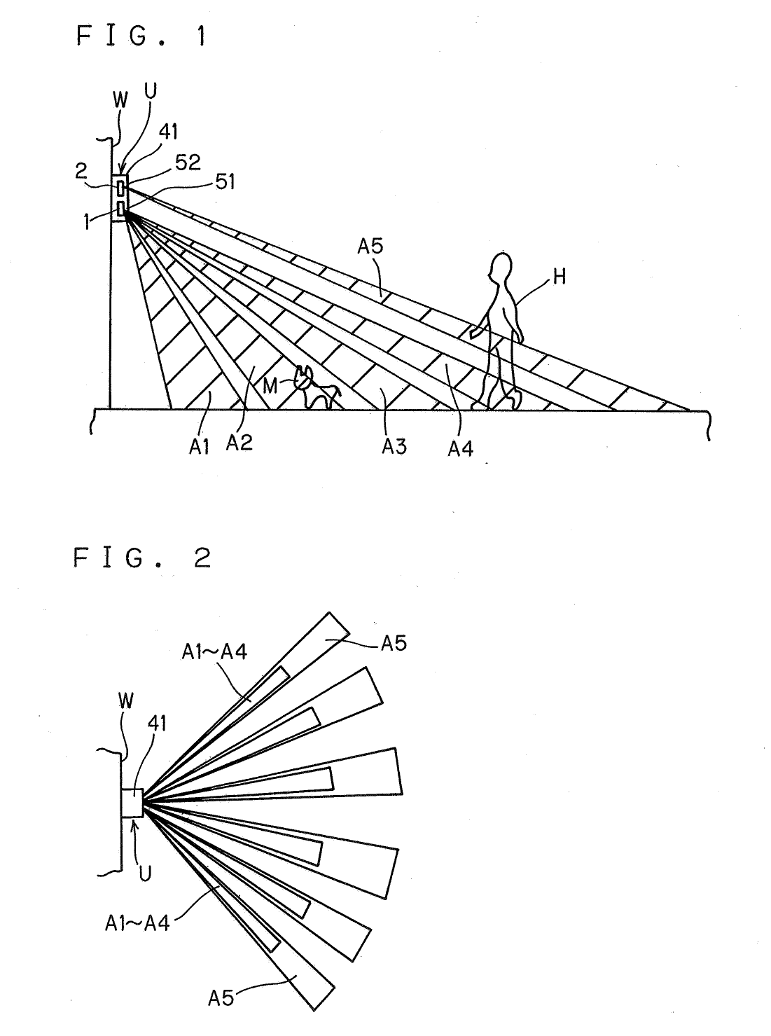

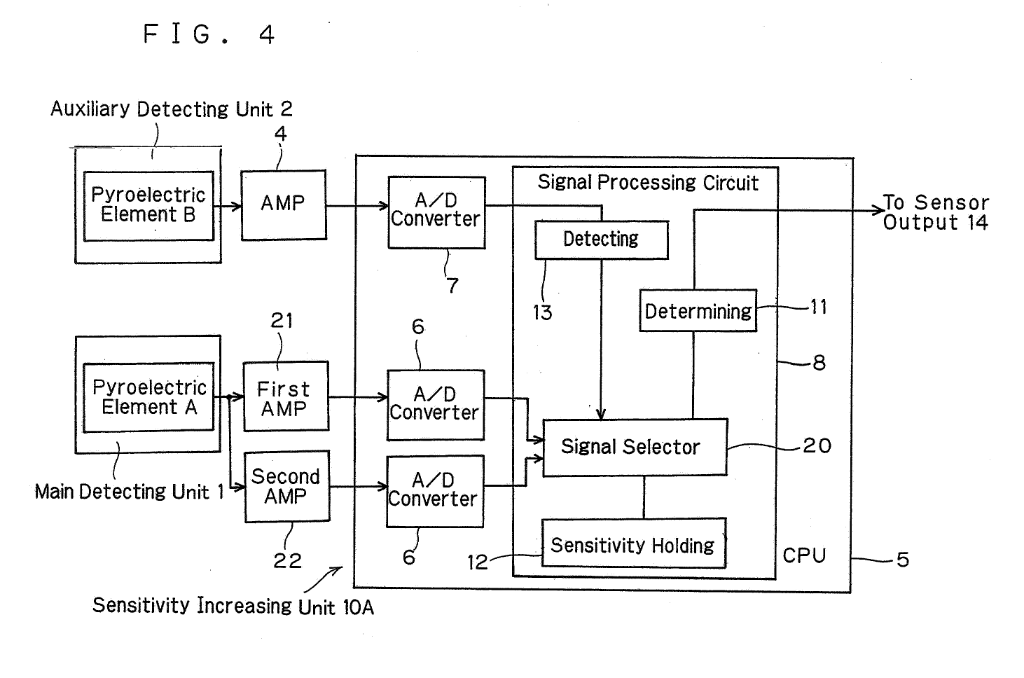

Referring to FIG. 1, there is shown, in a schematic side view, an optical arrangement of a sensitivity adjustable intrusion detecting system according to a first preferred embodiment of the present invention. The system shown therein includes a sensor unit U secured to, for example, an outer support surface W of a building such as, for example, a residence or a factory. The sensor unit U in turn includes a main detecting unit 1 and an auxiliary detecting unit 2. The main detecting unit 1 is made up of a passive type infrared detector (PIR sensor) that is utilized to “detect” main detection areas A1 to A4 defined within a supervised sector that is in turn defined out of the building. Similarly, the auxiliary detecting unit 2 is utilized to “detect” auxiliary detection areas identified by A5 and defined at respective perimeters (outskirts) of the main detection areas A1 to A4, that is, in a region distant from the sensor unit U. In the illustrated embodiment, the auxiliary detecting unit 2 is also made up of a passive type infrared detector (PIR sensor). The illustrated intrusion detecting system is so designed as to detect the presence of an intruder entering any one of the main detection areas A1 to A4 and then to output an intrusion detection signal that may be utilized to trigger an alarm circuit 15 (FIG. 3) on to issue an alarm signal.

Each of the main and auxiliary detecting units 1 and 2 includes a casing 41 enclosing therein a detecting element such as, for example, a pyroelectric element A or B (as shown in FIG. 3) and a detection processing circuit (not shown) for outputting a detection signal of a voltage level proportional to the amount of infrared rays incident upon the corresponding pyroelectric element A or B. The pyroelectric element A of the main detecting unit 1 defines the main detection areas A1 to A4 by means of an optical system 51 such as, for example, a Fresnel lens secured to the case 41 and positioned forwardly thereof. Similarly, the pyroelectric element B defines the auxiliary detection areas A5 by means of an optical system 52 similar in structure and function to those of the optical system 51. Infrared energies emitted from a human body H present within any one of the detection areas A1 to A5 can be collected by a corresponding one of the detection elements A and B through the associated optical system 51 or 52, wherefore the presence of the human body H can be detected. The human body H referred to above is in this case represented by an intruder.

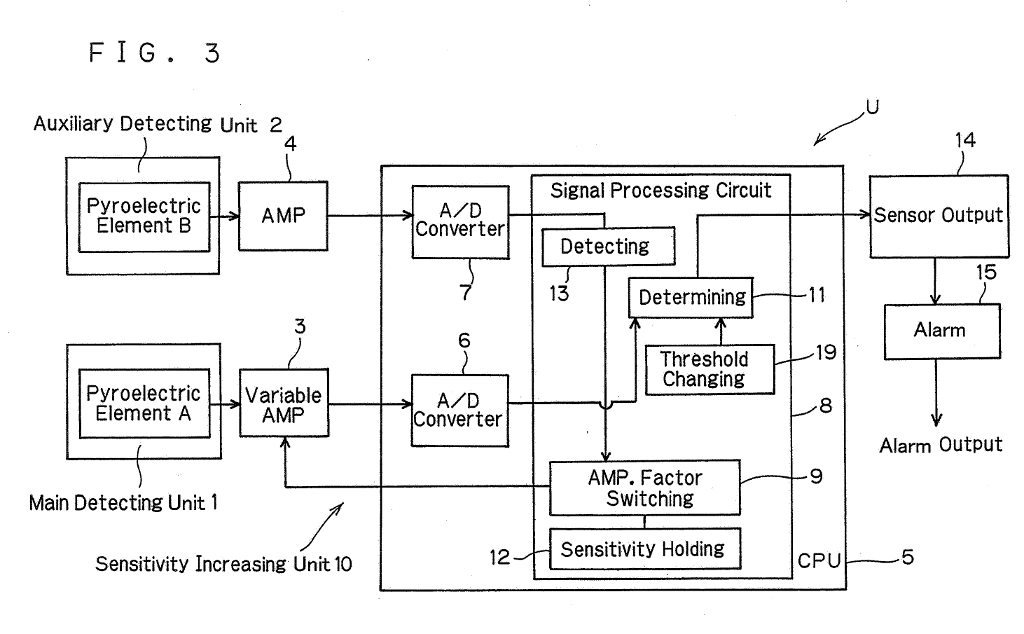

As hereinabove described, in the illustrated embodiment, the auxiliary detection areas A5 are defined in the outskirts of the main detection areas A1 to A4. Also, as shown in FIG. 2 in a top plan representation of the intrusion detecting system of the present invention from top, the detection areas A1 to A5 each having a predetermined width are so defined as to deploy in a radial pattern in a direction outwardly of the sensor unit U while spaced from each other. Each auxiliary detection area A5 extends radially outwardly from the sensor unit U a distance greater than the corresponding main detection area A1 to A4 and has an overlapping area with the main detection areas A1 to A4.

FIG. 3 is a circuit block diagram showing an electric circuit employed in the sensitivity adjustable intrusion detecting system of the structure described above.

In addition to the main and auxiliary detecting units 1 and 2, the intrusion detecting system also includes a gain variable amplifier 3 for amplifying a detection signal, outputted from the main detecting unit 1 and indicative of the presence of an object, and having a plurality of amplification factors, which can be selected in response to a selector signal applied thereto, and an amplifier 4 for amplifying a detection signal outputted from the auxiliary detecting unit 2 and indicative of the presence of an object. The gain variable amplifier 3 may include a frequency characteristic variable amplifier, that is, an amplifier having a large amplification factor only in low frequency region or high frequency region so as to increase the detecting sensitivity of the human body H. The detection signal generated from each of the main and auxiliary detecting units 1 and 2 is supplied to a central processing unit (CPU) 5 via the respective amplifiers 3 and 4. The central processing unit 5 includes a first analog-to-digital (A/D) converter 6 for converting a digital output, outputted from the amplifier 3, into a digital signal, a second analog-to-digital (A/D) converter 7 for converting a digital output, outputted from the amplifier 4, into a digital signal, and a signal processing circuit 8.

The signal processing circuit 8 referred to above in turn includes a detecting circuit 13 for detecting the presence of an object in reference to the magnitude of the detection signal outputted from the auxiliary detecting unit 2 within one of the auxiliary detection areas A5, an amplification factor switching circuit 9, a determining circuit 11 and an increased sensitivity holding circuit 12. The amplification factor switching circuit 9 is operable in response to the detection signal associated with the auxiliary detection area A5 to generate a switching signal necessary to switch the amplification factor of the variable gain amplifier 3 over to a higher amplification factor. Based on the detection signal associated with the auxiliary detection areas A5, it can be suspected that an object is approaching the main detection areas A1 to A4. The variable gain amplifier 3 and the amplification factor switching circuit 9 altogether form a sensitivity increasing unit 10 for increasing the detecting sensitivity of the main detecting unit 1 in response to detection made by the auxiliary detecting unit 2.

The determining circuit 11 referred to above is operable to determine, based on a preset determining threshold value representative of a human body detection level, whether or not the detection signal outputted from the main detecting unit 1 is indicative of the presence of the human body H. The increased sensitivity holding circuit 12 referred to above is operable to retain for a predetermined hold time, the detecting sensitivity of the main detecting unit so increased by the sensitivity increasing unit 10. Although in general, the determining circuit 11 is effective to substantially avoid an erroneous operation of the system resulting from detection of a small animal M, such undesirable erroneous operation of the system can be substantially assuredly avoided when the detecting sensitivity of the main detecting unit 1 so increased is retained for the predetermined hold time.

In other words, assuming that an object moves from the auxiliary detection areas A5 towards the main detection areas A1 to A4, since the human body H has a great height as compared with that of the small animal M and, also, since the length of time the human body H resides within the main and auxiliary detection areas simultaneously is larger than that the small animal M does, the main detecting unit 1 can be held in a condition with its detecting sensitivity increased for the length of time during which the human body H remains within the auxiliary detection area A5 and, accordingly, the presence of the human body H can be detected even though the hold time is reduced.

In contrast thereto, since the small animal M has a relatively small height and, therefore, the small animal M when detected as present in the auxiliary detection area A5 can relatively quickly shift from such auxiliary detection area A5 to the main detection areas A1 to A4, the small animal M will not be detected as presenting the main detection areas A1 to A4. Thus, in the main detection areas A1 to A4, when the hold time during which the increased detecting sensitivity is retained is set to a small length of time, the erroneous operation caused by the small animal M can be substantially assuredly avoided thanks to the difference in manner of movement between the human body H and the small animal M.

In the practice of the present invention, the auxiliary detecting unit 2 has a detecting sensitivity preset to a value higher than that of the main detecting unit 1 so that the auxiliary detecting unit 2 can assuredly detect the presence of the object. This design is effective in that no alarm will not issued even though the auxiliary detecting unit 2 detects the presence of the object and, therefore, no erroneous operation of the system will occur. Thus, since the detecting sensitivity of the main detecting unit 1 is altered in response to detection by the auxiliary detecting unit 2 and when such detecting sensitivity of the main detecting unit 1 is so increased at the time the necessity to detect the presence or absence of the human body H entering in the main detection areas A1 to A4 encompassed within the supervised sector, the detecting sensitivity of the main detecting unit 1 is increased so that the human body H can be assuredly detected under the environment where the human body H is difficult to be detected because of a small difference between the human body H and the ambient temperature, thereby avoiding an erroneous operation.

The detection signal indicative of the human body H, which is supplied from the main detecting unit 1 having the detecting sensitivity increased by the sensitivity increasing unit 10 and the presence of the human body H is subsequently determined by the determining circuit 11, is thereafter supplied to a sensor signal output section 14, from which an intrusion detection (sensor) signal is subsequently outputted. An alarm circuit 15 operates in response to this intrusion detection signal to issue an alarm.

As described above, in the practice of the present invention, since the detecting sensitivity of the main detecting unit 1 is altered in response to detection in the auxiliary detection area A5 by the auxiliary detecting unit 2 and when such detecting sensitivity of the main detecting unit 1 is so increased at the time the necessity to detect the presence or absence of the human body H entering in one of the main detection areas A1 to A4 encompassed within the supervised sector, the detecting sensitivity of the main detecting unit 1 is increased so that the human body H can be assuredly detected under the environment where the human body H is difficult to be detected, thereby avoiding an erroneous operation.

In the foregoing embodiment the sensitivity increasing unit 10 has been described as operable to increase the detecting sensitivity of the main detecting unit 1 by causing the amplification factor switching circuit 9 to increase the amplification factor of the variable amplifier 3 associated with the main detecting unit 1. However, instead thereof, the detecting sensitivity of the main detecting unit 1 may be increased by causing a threshold changing circuit 19 to lower the determining threshold value, which is used by the determining circuit 11 in the signal processing circuit 8 of the central processing unit 5 to determine the presence of a human body.

It is to be noted that although in the foregoing embodiment reference has been made to the use of the increased sensitivity holding circuit 12 for holding the increased sensitivity of the main detecting unit 1 for the predetermined hold time, the use of such increased sensitivity holding circuit 12 is not always essential in the practice of the present invention and may be deleted accordingly.

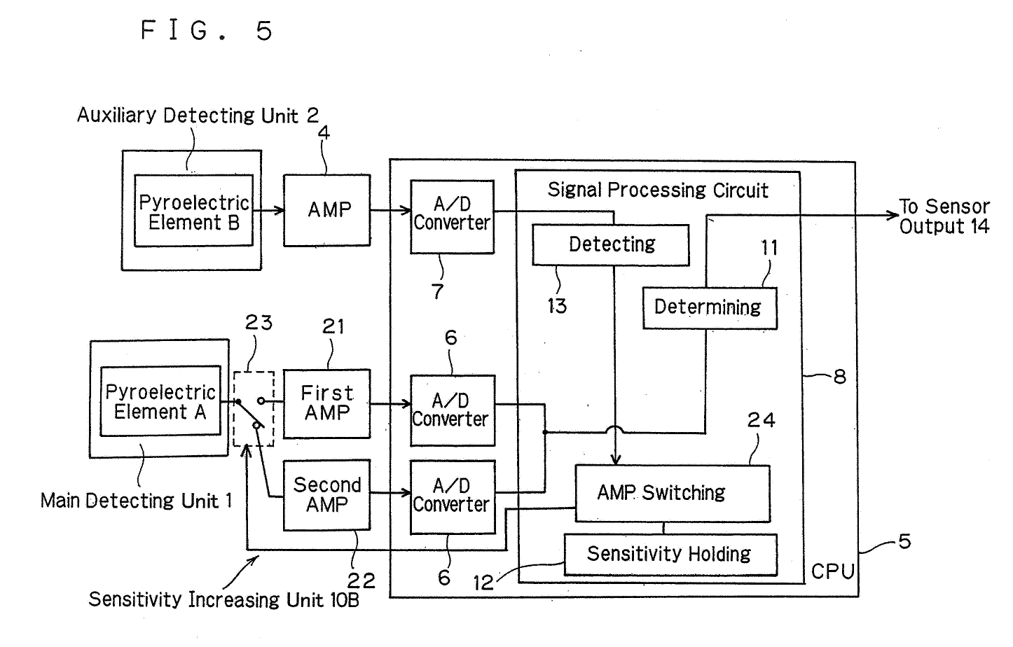

A second preferred embodiment of the present invention will now be described with particular reference to FIG. 4. In this second embodiment, the sensitivity increasing unit now identified by 10A is of a structure different from the sensitivity increasing unit 10 employed in the foregoing embodiment. As shown in FIG. 4, the sensitivity increasing unit 10A includes first and second amplifiers 21 and 22 having different first and second amplification factors and operable to amplify the detection signal indicative of the presence of an object that is supplied from the main detecting unit 1, and a signal selector circuit 20 for selecting one of respective outputs from the first and second amplifiers 21 and 22.

Other structural features of the second embodiment than the sensitivity increasing unit are substantially similar to those shown and described in connection with the foregoing first embodiment and, therefore, the details thereof are not reiterated for the sake of brevity.

According to the second embodiment, the second amplification factor of the second amplifier 22 is set to be higher than the first amplification factor of the first amplifier 21 and thus the second amplifier 22 has a detecting sensitivity higher than that of the first amplifier 21. Upon detection of the presence of an object with the auxiliary detecting unit 2, the output signal from the second amplifier 22 is selected by the signal selecting circuit 20 so that the detecting sensitivity of the main detecting unit 1 can be increased. Accordingly, the detecting sensitivity of the main detecting unit 1 can be increased with a simplified structure.

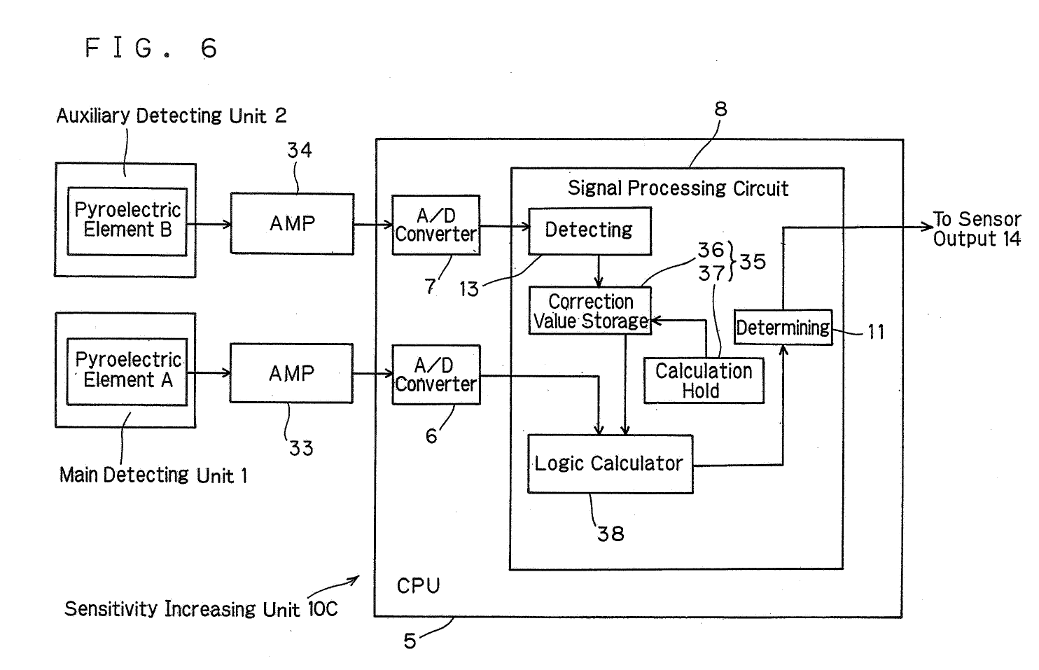

Similarly, in a third preferred embodiment of the present invention shown in FIG. 5, the sensitivity increasing unit different in structure from the sensitivity increasing unit 10 employed in the foregoing embodiment is employed and identified by 10B. Specifically, the sensitivity increasing unit 10B shown in FIG. 5 includes first and second amplifiers 21 and 22 having different first and second amplification factors and operable to amplify the detection signal indicative of the presence of an object that is supplied from the main detecting unit 1, a switching section 23 and an amplifier switching circuit 24 for triggering the switching section 23 for selectively connecting the main detecting unit 1 with one of the first and second amplifiers 21 and 22. Other structural features of the third embodiment than the sensitivity increasing unit are substantially similar to those shown and described in connection with the foregoing first embodiment and, therefore, the details thereof are not reiterated for the sake of brevity.

According to the third embodiment, in a manner similar to the second embodiment, the second amplification factor of the second amplifier 22 is set to be higher than the first amplification factor of the first amplifier 21 and, upon detection of the presence of an object with the auxiliary detecting unit 2, the main detecting unit 1 can be connected with the second amplifier 22 through the switching section 23 then so triggered by the amplifier switching circuit 24, so that the detecting sensitivity of the main detecting unit 1 can be increased. Accordingly, the detecting sensitivity of the main detecting unit 1 can be increased with a simplified structure. In the foregoing second and third embodiments, the second amplifier 22 may be an amplifier having a characteristic different from the first amplifier 21, that is, an amplifier having amplification factor larger than the first amplifier 21 only in low frequency region or high frequency region.

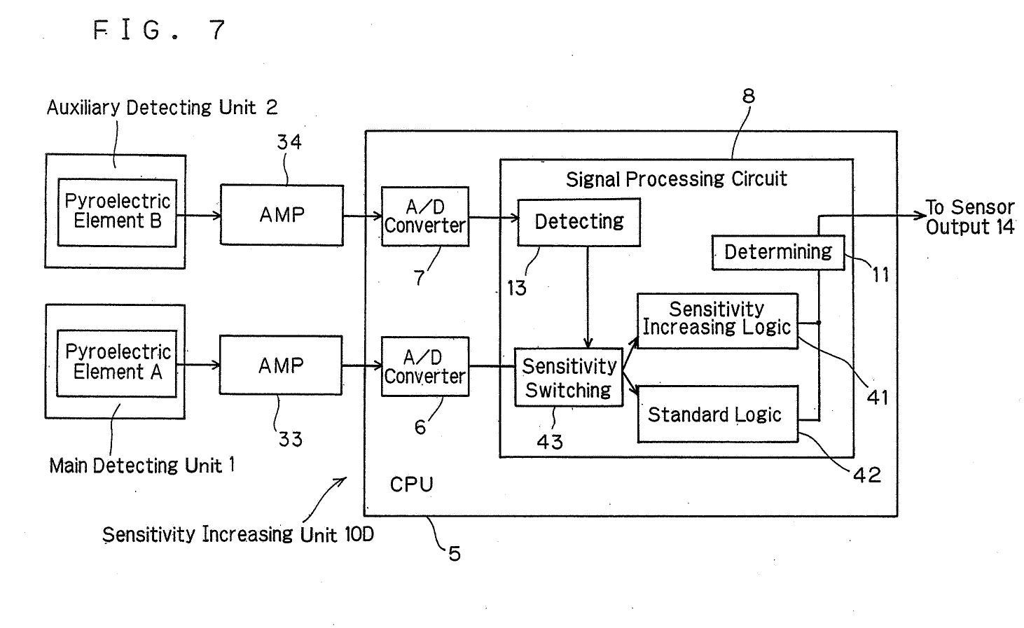

A fourth preferred embodiment of the present invention shown in FIG. 6 makes use of the sensitivity increasing unit which is different in structure from the sensitivity increasing unit 10 employed in the foregoing embodiment. The sensitivity increasing unit employed in this fourth embodiment is now identified by 10C in FIG. 6 and includes a signal hold circuit 35 for holding a detection signal indicative of the presence of an object outputted from the auxiliary detecting unit 2, and a signal calculating circuit (a logic calculating circuit) 38 operable, when the auxiliary detecting unit 2 detects the presence of an object and the main detecting unit 1 subsequently detects the presence of the object (human body H), to perform a calculation such as, for example, an addition or a multiplication, on a detection signal indicative of the presence of an object, outputted from the main detecting unit 1, and the detection signal outputted from the auxiliary detecting unit 2 and subsequently retained by the signal hold circuit 35. The signal hold circuit 35 referred to above includes a correction value storage 36 for storing as a correction value, the detection signal supplied from the auxiliary detecting unit 2 when the latter detects the presence of the object, and a calculation hold section 37 in the form of a timer for holding the correction value for a predetermined hold time. Other structural features of the third embodiment than the sensitivity increasing unit are substantially similar to those shown and described in connection with the foregoing first embodiment and, therefore, the details thereof are not reiterated for the sake of brevity.

According to the fourth embodiment described above, since when the auxiliary detecting unit 2 detects the presence of an object and the main detecting unit 1 subsequently detects the presence of the object, the detection signal indicative of the presence of the object outputted from the main detecting unit 1 is calculated with the detection signal indicative of the presence of the object outputted from the auxiliary detecting unit 2 and then held by the signal hold circuit 35, the detection signal indicative of the presence of the object outputted from the main detecting unit 1 can be increased with the detecting sensitivity of the main detecting unit 1 increased consequently. Accordingly, the detecting sensitivity of the main detecting unit 1 can be increased advantageously with a simplified structure.

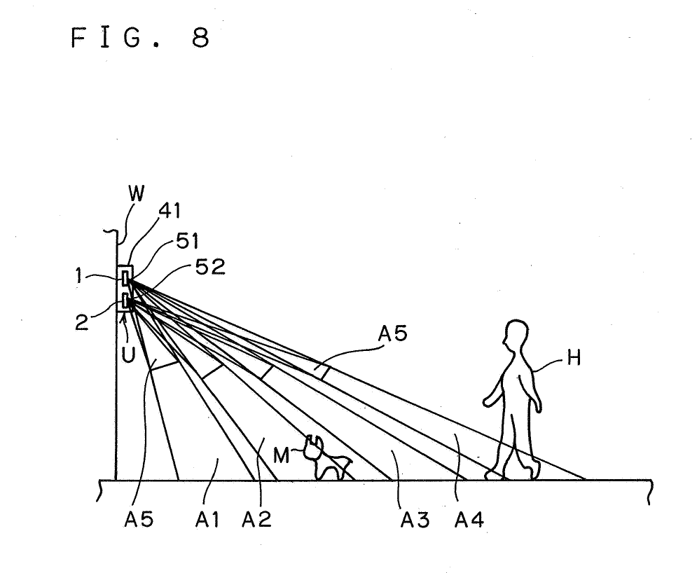

A fifth preferred embodiment of the present invention will now be described in detail with particular reference to FIG. 7. The sensitivity increasing unit employed in this fifth embodiment is different in structure from the sensitivity increasing unit 10C employed in the fourth embodiment shown in and described with reference to FIG. 6. Referring to FIG. 7, the sensitivity increasing unit now identified by 10D includes two sensitivity processing circuits 41 and 42 capable of performing a signal processing of the detection signal, indicative of the presence of an object (human body H) outputted from the main detecting unit 1, with one of different detecting sensitivities being used. The two sensitivity processing circuits includes a first sensitivity processing circuit (a sensitivity increasing logic) 41 for processing the detection signal so that the detecting sensitivity can be increased by either reducing the pulse count of the signal or reducing the length of time required to perform the signal processing, and a second sensitivity processing circuit (a normal logic) 42 for processing the detection signal using the standard detecting sensitivity.

The sensitivity increasing unit 10D also includes a sensitivity switching circuit 43 operable in response to detection of the presence of an object with the auxiliary detecting unit 2 to select one of the sensitivity processing circuits 41 and 42. When the auxiliary detecting unit 2 detects the presence of an object, the sensitivity switching circuit 43 selects the first sensitivity processing circuit 41, but when no object is detected, the sensitivity switching circuit 43 selects the second sensitivity processing circuit 42. Other structural features of the third embodiment than the sensitivity increasing unit 10D are substantially similar to those shown and described in connection with the foregoing fourth embodiment and, therefore, the details thereof are not reiterated for the sake of brevity. The first sensitivity processing circuit 41 may include, other than a circuit to increase the detecting sensitivity in the whole frequency region, a circuit to increase the detecting sensitivity only in low frequency region or high frequency region.

According to the fifth embodiment, since when the auxiliary detecting unit 2 detects the presence of an object, the signal processing of the detection signal indicative of the presence of an object outputted from the main detecting unit 1 can be switched so as to be performed with the increased detection sensitivity, the detecting sensitivity of the main detecting unit 1 can be increased. Accordingly, with a simplified structure, the sensitivity of the main detecting unit 1 can be increase advantageously.

FIG. 8 illustrates a sixth preferred embodiment of the present invention, which will now be described in detail. While in the first embodiment shown in and described with reference to FIGS. 1 to 3, the auxiliary detection areas A5 are defined at the outskirts of the main detection areas A1 to A4, respectively, the auxiliary detection areas A5 in the sixth embodiment are defined within the respective main detection areas A1 to A4. Other structural features of the sixth embodiment than that described above are substantially similar to those shown and described in connection with the foregoing first embodiment and, therefore, the details thereof are not reiterated for the sake of brevity.

According to the sixth embodiment described above, by changing the focal distance of the auxiliary detecting unit 2, respective detecting characteristics of the auxiliary and main detection areas A5 and A1 to A4 are changed. In other words, considering that the human body H has a height greater than that of the small animal M, the human body H, found at a location relatively near to the auxiliary detecting unit, is allowed to be detected in the auxiliary detection areas A5, whereas the small animal M, found at a location relatively far from the auxiliary detecting unit 2 because of the difference in height between the human body and the small animal, is not allowed to be detected in the auxiliary detection areas A5. Accordingly, with respect to the small animal M, since the small animal M is in no way detected in the auxiliary detection areas A5, the detecting sensitivity for each of the main detection areas cannot be increased and, hence, the small animal M if existing in the main detection areas A1 to A4 will hardly be detected, but the human body H can be detected assuredly, with the undesirable erroneous operation substantially avoided consequently.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, although in any one of the foregoing embodiments of the present invention, reference has been made to the use of the passive type infrared detector (PIR sensor) for the auxiliary detecting unit 2, the auxiliary detecting unit 2 may not be always limited thereto, but may be employed in the form of a MW (microwave) sensor, an image processing device utilizing a CCD camera, an AIR sensor or a ultrasonic active type sensor.

Accordingly, such changes and modifications are, unless they depart from the scope of the present invention as delivered from the claims annexed hereto, to be construed as included therein.

What is claimed is:

1. A sensitivity adjustable intrusion detecting system, which comprises:
a main detecting unit including a passive type infrared detector for detecting an object present within a main detection area encompassed within a supervised sector;
an auxiliary detecting unit for detecting an object present within a auxiliary detection area defined in the vicinity of or inside the main detection area; and
a sensitivity increasing unit for increasing the detecting sensitivity of the main detecting unit in response to detection by the auxiliary detecting unit.

2. The sensitivity adjustable intrusion detecting system as claimed in claim 1, further comprising an increased sensitivity holding circuit for holding the detecting sensitivity of the main detecting unit, which has been increased, for a predetermined hold time.

3. The sensitivity adjustable intrusion detecting system as claimed in claim 1, wherein the sensitivity increasing unit comprises an amplifier for amplifying a detection signal indicative of the presence of an object, which is outputted from the main detecting unit, and an amplification factor switching circuit for increasing the amplification factor of the amplifier.

4. The sensitivity adjustable intrusion detecting system as claimed in claim 1, wherein the sensitivity increasing unit comprises a threshold changing circuit for lowering a determination threshold value in a signal processing circuit for processing the detection signal indicative of the object outputted from the main detecting unit.

5. The sensitivity adjustable intrusion detecting system as claimed in claim 1, wherein the sensitivity increasing unit comprises two amplifier having different amplification factors and operable to amplify a detection signal indicative of an object, which has been outputted from the main detecting unit, and a signal selecting circuit for selecting one of respective output signals of the amplifiers.

6. The sensitivity adjustable intrusion detecting system as claimed in claim 1, wherein the sensitivity increasing unit comprises two amplifier having different amplification factors and operable to amplify a detection signal indicative of an object, which has been outputted from the main detecting unit, and an amplifier switching circuit for switching from one of the amplifiers over to the other of the amplifiers.

7. The sensitivity adjustable intrusion detecting system as claimed in claim 1, wherein the sensitivity increasing unit comprises a signal holding circuit for holding a detection signal outputted from the auxiliary detecting unit when the latter detects an object, and a signal calculating circuit for calculating and outputting a detection signal indicative of an object, which is outputted from the main detecting unit when the latter detects such object after the auxiliary detecting unit has detected the object, and the detection signal of the auxiliary detecting unit held in the signal holding circuit.

8. The sensitivity adjustable intrusion detecting system as claimed in claim 1, wherein the sensitivity increasing unit comprises two sensitivity processing circuits for causing a signal processing for processing the detection signal indicative of the object, which has been outputted from the main detecting unit, to be performed according to one of different detection sensitivities and a sensitivity switching circuit for selecting one of the sensitivity processing circuits.
